(19) United States
(12) Patent Application Publication
(10) Pub. No.: US 2024/0026997 A1
(43) Pub. Date: Jan. 25, 2024

(54) PIPE COMPRISING AT LEAST ONE STIFFENED FLEXIBLE DUCT AND AIRCRAFT COMPRISING AT LEAST ONE SUCH PIPE

(71) Applicant: Airbus Operations SAS, TOULOUSE (FR)

(72) Inventors: Simon FOUCART-GAUDY, TOULOUSE (FR); Vincent DELPY, TOULOUSE (FR); Gérard MILLET, TOULOUSE (FR)

(21) Appl. No.: 18/353,278

(22) Filed: Jul. 17, 2023

(30) Foreign Application Priority Data
Jul. 25, 2022 (FR) 2207592

(51) Int. Cl. F16L 3/26; F16L 3/14; F24F 13/02

(52) U.S. Cl. CPC F16L 3/26; F16L 3/14; F24F 13/0218

(57) ABSTRACT

A pipe comprising at least one flexible duct, wherein the pipe comprises at least one stiffening band, which is pressed against the duct over at least some of its length, extends along a longitudinal direction substantially parallel to the axis of the duct and has, at least in one state, considerable rigidity along the longitudinal direction, the stiffening band being configured to deform elastically between a rolled-up state, when the cross sections of the stiffening band are rectilinear, and an elongate and rigid state, when the cross sections of the stiffening band are curved. An aircraft comprising at least one such pipe.

### CROSS-REFERENCES TO RELATED APPLICATIONS

This application claims the benefit of French Patent Application Number 2207592 filed on Jul. 25, 2022, the entire disclosure of which is incorporated herein by way of reference.

### FIELD OF THE INVENTION

The present application relates to a pipe comprising at least one stiffened flexible duct and to an aircraft comprising at least one such pipe.

### BACKGROUND OF THE INVENTION

According to one embodiment, shown in FIG. 1, a pipe 10 comprises multiple ducts 10.1, 10.2, 10.3 positioned end to end and connected to one another in leaktight fashion. The pipe 10 is connected to a structure 12 by virtue of fixing collars 14 positioned along the pipe 10, such as at the attachment regions of the ducts 10.1, 10.2, 10.3 for example. The pipe 10 has a slight incline P along a direction from the first section 10.1 to the third section 10.3 to allow a liquid to flow under the effect of gravity. According to one configuration, the first and third sections 10.1, 10.3 are metallic, stiff and retain the incline P. To reduce the mass on board an aircraft, the second section 10.2 is made of flexible plastics material. Owing to the mass of liquid circulating in it and its flexibility, the second section 10.2 can sag and create a basin 16 in which the liquid can stagnate.

Consequently, for certain applications like drinking water pipes for example, most of the sections are metallic and stiff to limit the risks of basins appearing, even if this would lead to an increase in the on-board mass.

### SUMMARY OF THE INVENTION

The present invention aims to overcome all or some of the drawbacks of the prior art.

To that end, one subject of the invention is a pipe comprising at least one flexible duct having an axis, an inner face directed toward the axis, an outer face opposite to the inner face, first and second ends, a lower generatrix, and a length corresponding to a distance separating the first and second ends. According to the invention, the pipe comprises at least one stiffening band, which is pressed against the duct over at least some of its length, extends along a longitudinal direction substantially parallel to the axis of the duct and has, at least in one state, considerable rigidity along the longitudinal direction. In addition, the stiffening band is metallic and configured to deform elastically between a rolled-up state, when the cross sections of the stiffening band are rectilinear, and an elongate and rigid state, when the cross sections of the stiffening band are curved, the stiffening band having a first surface which is intended to be pressed against the duct and is curved and concave in the elongate and rigid state.

Even if the duct of plastics material is flexible, when the stiffening band is pressed against the duct, the stiffening band gives the duct significant rigidity along the longitudinal direction, limiting the risks of the duct sagging.

According to other features, taken individually or in combination:
each stiffening band comprises first and second lateral edges that are substantially parallel to the longitudinal direction and positioned on either side of the lower generatrix of the duct;
the first and second lateral edges are positioned substantially symmetrically in relation to the lower generatrix;
the pipe comprises at least one connection connecting the stiffening band and the duct;
cutouts are made in the stiffening band to reduce its mass.

Another subject of the invention is an aircraft comprising at least one pipe according to one of the preceding features.

### BRIEF DESCRIPTION OF THE DRAWINGS

Further features and advantages will become apparent from the following description of the invention, which description is given solely by way of example, with reference to the appended drawings in which:

FIG. 1 is a schematic cross section through a duct, illustrating an embodiment of the prior art,

FIG. 2 is a schematic cross section through a duct, illustrating one embodiment of the invention,

FIG. 3 is a cross section, along the line III-III in FIG. 2, of a duct, illustrating one embodiment of the invention,

FIG. 4 is a perspective view of a stiffening band in a rolled-up first state, illustrating one embodiment of the invention,

FIG. 5 is a perspective view of a stiffening band in an elongate and rigid second state, illustrating one embodiment of the invention,

FIG. 6 is a perspective view of a stiffened duct, illustrating one embodiment of the invention,

FIG. 7 is a cross section through a stiffened duct, illustrating one embodiment of the invention,

FIG. 8 is a perspective view of a stiffening band, illustrating one embodiment,

FIG. 9 is a cross section through the stiffening band that can be seen in FIG. 8,

FIG. 10 is a perspective view of a stiffening band, illustrating another embodiment,

FIG. 11 is a cross section through the stiffening band that can be seen in FIG. 10,

FIG. 12 is a cross section through a duct having the stiffening band that can be seen in FIG. 10,

FIG. 13 is a perspective view of a stiffening band, illustrating another embodiment, and

FIG. 14 is an aircraft which may include one of the foregoing embodiments of the pipes according to the present invention.

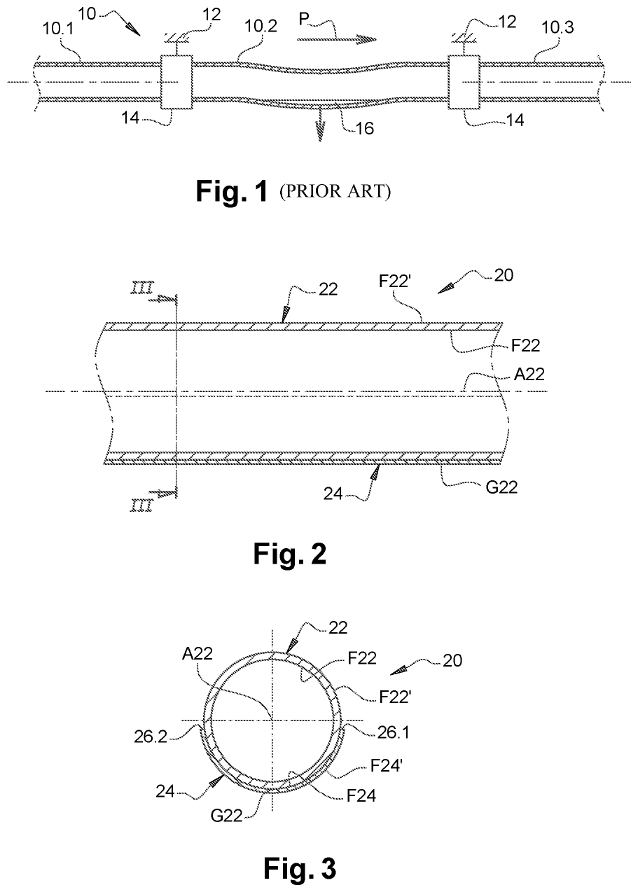

### DETAILED DESCRIPTION OF THE PREFERRED EMBODIMENTS

According to one application, an aircraft 100 (see FIG. 14) comprises at least one pipe 20 configured to drain a liquid, such as water for example. Of course, the invention is not limited to this application.

The pipe 20 comprises at least one flexible duct 22 made of plastics material, for example. This duct 22 has a mass considerably lower than that of a metal duct.

According to one configuration, the pipe 20 comprises multiple ducts, including a flexible duct 22, which are positioned end to end and are connected together in leak-tight fashion by attachment systems made of plastics material, for example. The pipe 20 is connected to a structure, such as the structure of an aircraft, by fixing collars positioned evenly along the pipe 20.

The attachment systems and the fixing collars are not described further since they may be identical to those of the prior art.

As illustrated in FIG. 6, the duct 22 is tubular, comprises an axis A22, an inner face F22 directed toward the axis A22 and an outer face F22′ opposite to the inner face F22, and extends between first and second ends 22.1, 22.2. According to one configuration, the first and second ends 21.1, 22.2 each take the form of an annular edge face positioned in a transverse plane substantially perpendicular to the axis A22. By “substantially” it is meant that there is no more than 10% deviation. The duct 22 has a length which corresponds to a distance separating the first and second ends 22.1, 22.2 along a generatrix.

During operation, the duct 22 comprises a lower generatrix G22 which corresponds to the lowest generatrix of the duct 22 in the vertical direction.

The pipe 20 comprises at least one stiffening band 24 which is placed against the duct 22, more specifically against the outer face F22′ of the duct 22, and extends over at least some of the length of the duct 22. According to a configuration that can be seen in FIG. 6, the stiffening band 24 extends over the entire length of the duct 22. According to another configuration, the stiffening band 24 extends only over some of the length of the duct 22. According to another configuration, the pipe 20 comprises multiple stiffening bands 24 which are placed against the same duct 22 and are offset in relation to one another along the length of the duct 22.

According to another configuration that can be seen in FIG. 7, the pipe 20 comprises multiple stiffening bands 24 superposed on one another.

Irrespective of the embodiment, the pipe 20 comprises at least one stiffening band 24, which is pressed against the duct 22 over at least some of the length of the duct 22, extends along a longitudinal direction substantially parallel to the axis A22 of the duct 22 and has, at least in one state, considerable rigidity along the longitudinal direction. As a result, when it is pressed against the duct 22, the stiffening band 24 gives the duct 22 considerable rigidity along the longitudinal direction, limiting the risks of the duct 22, which remains rectilinear, sagging.

According to one configuration, the stiffening band 24 has, in planes perpendicular to the longitudinal direction, a curvature substantially equal to the curvature of the outer face F22′ of the duct 22. Owing to this curvature, the stiffening band 24 has a large moment of inertia along the longitudinal direction, which gives it considerable rigidity along the longitudinal direction and thus limits the risks of bending.

According to one embodiment, each stiffening band 24 has a substantially rectangular perimeter, comprising first and second lateral edges 26.1, 26.2 which are substantially mutually parallel and are arranged parallel to the axis A22 of the duct 22 (or to the longitudinal direction) and first and second transverse edges 28.1, 28.2 substantially perpendicular to the first and second lateral edges 26.1, 26.2. The stiffening band 24 has a first surface F24 intended to be pressed against the duct 22 and a second surface F24′ opposite to the first surface F24.

According to one configuration, the stiffening band 24 has a width (distance separating the first and second lateral edges 26.1, 26.2) substantially equal to or slightly less than half of the circumference of the duct 22. According to one arrangement, each stiffening band 24 is positioned against the duct 22 in order that the first and second lateral edges 26.1, 26.2 are positioned on either side of the lower generatrix G22, preferably such that they are substantially symmetrical in relation to the lower generatrix G22.

To give an order of magnitude, the stiffening band 24 has a thickness (distance separating the first and second surfaces F24, F24′) of around one millimeter, comprised between 0.5 and 1.5 mm, a width (distance separating the first and second lateral edges 26.1, 26.2) of around 1 to 5 cm and a length (distance separating the first and second transverse edges 28.1, 28.2) greater than 10 cm.

The pipe 20 comprises at least one connection 30 connecting the stiffening band 24 and the duct 22. According to one configuration, the connection 30 is an adhesive or a film of adhesive interposed between the stiffening band 24 and the outer face F22′ of the duct 22. According to another configuration, the connection 30 comprises clamping collars 30.1, 30.2, which are distributed between the first and second ends 22.1, 22.2 and clamp the stiffening band 24 and the duct 22.

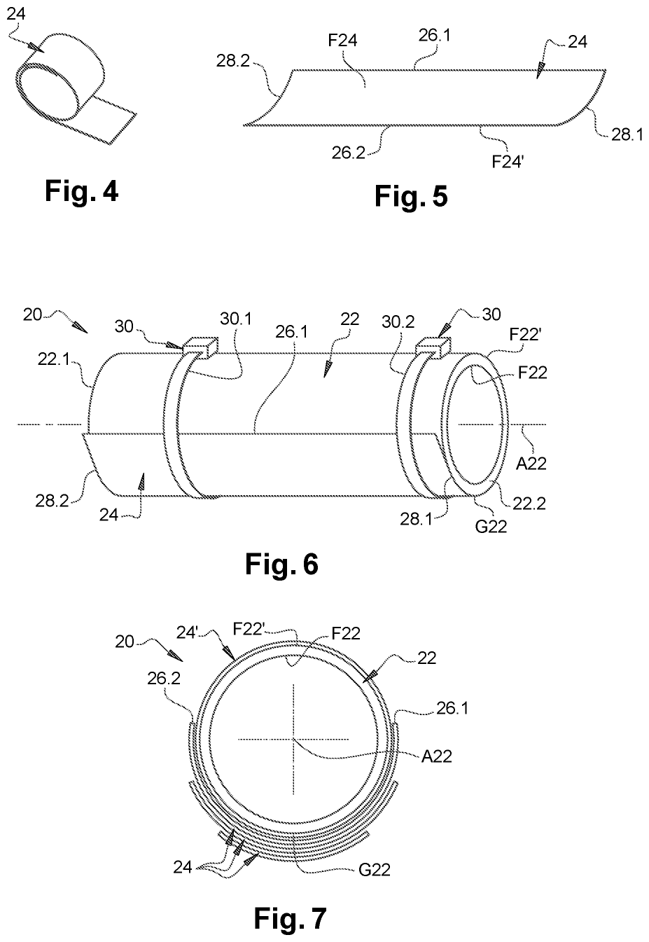

According to one configuration, the stiffening band 24 is metallic and configured to deform elastically between a rolled-up state, when the cross sections of the stiffening band 24 are rectilinear, as illustrated in FIG. 4, and an elongate and rigid state, when the cross sections of the stiffening band 24 are curved, with the first surface F24 that is intended to be pressed against the duct 22 being curved and concave, as illustrated in FIG. 5. This configuration makes it possible to reduce the bulk of the stiffening band 24 when it is not in use. As a result, when they are not in use, the flexible duct 22 and the stiffening band 24 can be stored in a rolled-up state.

The stiffening band 24 comprises at least one longitudinal reinforcer 32, which is substantially parallel to the longitudinal direction (or to the first or second lateral edge 26.1, 26.2), extends virtually over the entire length of the stiffening band and has considerable rigidity along the longitudinal direction. According to one arrangement, the stiffening band 24 comprises first and second longitudinal reinforcers 32, 32′ positioned at the first and second lateral edges 26.1, 26.2, respectively.

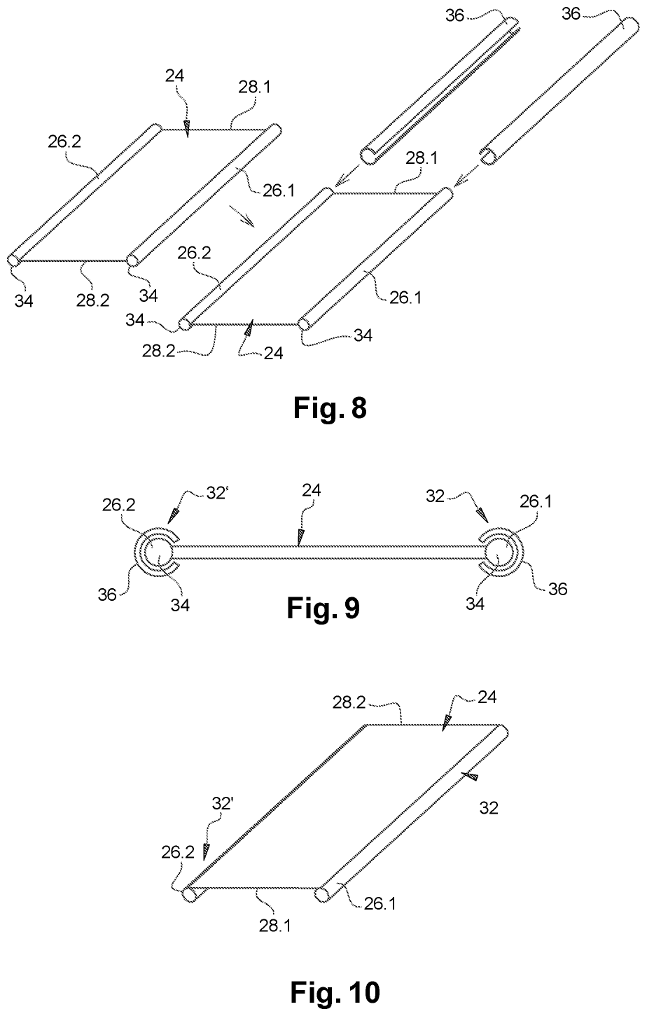

According to an embodiment that can be seen in FIGS. 8 and 9, the stiffening band 24 is made of flexible or semi-rigid plastics material and comprises first and second longitudinal reinforcers 32, 32′ positioned at the first and second lateral edges 26,1, 26.2, respectively. Each of the first and second longitudinal reinforcers 32, 32′ comprises a bead 34, which is secured to the stiffening band 24 and is made in one piece with the latter, and a rigid tube 36, which is split over its length and threaded onto the bead 34. The bead 34 has a round cross section. In addition, the inside diameter of the tube 36 is substantially equal to or very slightly greater than the diameter of the bead 34.

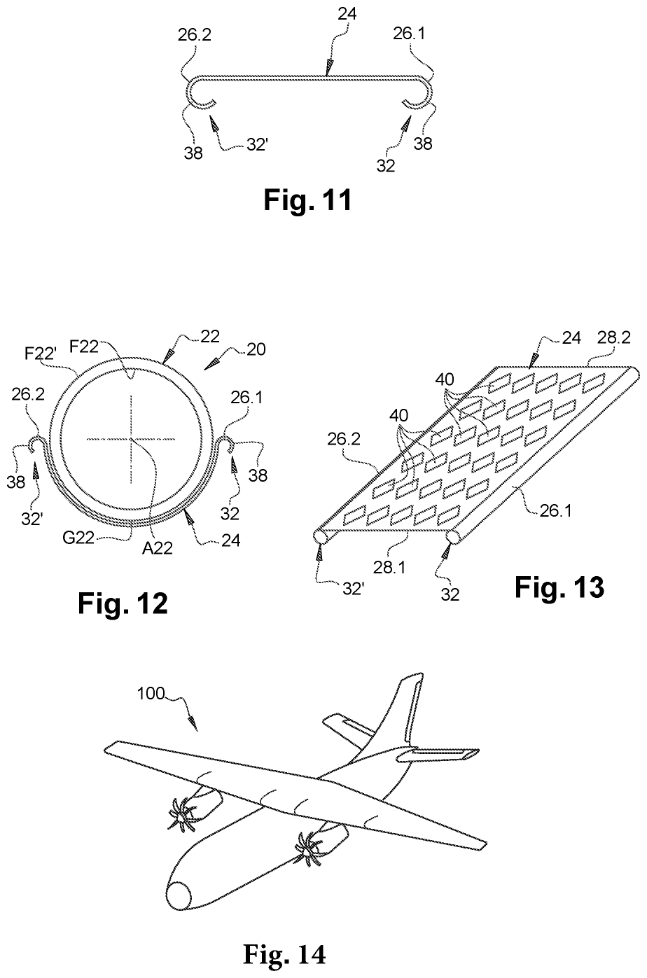

According to another embodiment that can be seen in FIGS. 10 to 12, the stiffening band 24 is metallic or made of semi-rigid plastics material and comprises first and second longitudinal reinforcers 32, 32′ positioned at the first and second lateral edges 26,1, 26.2, respectively. Each of the first and second lateral edges 26.1, 26.2 has a curved or folded profile 38 forming a longitudinal reinforcer 32, 32′. According to one embodiment, the profile 38 has a C-shaped or U-shaped cross section.

According to one configuration, to reduce its mass, cutouts are made in the stiffening band 24, as illustrated in FIG. 13. By way of example, the stiffening band 24 comprises cutouts 40 distributed evenly over the entire surface of the stiffening band 24.

According to another embodiment, the pipe 20 comprises at least one stiffening band 24 which extends over the entire circumference of the duct 22, as illustrated in FIG. 7.

These different embodiments make it possible to reduce the mass of the pipe and the production costs.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A pipe comprising:
at least one flexible duct having an axis, an inner face directed toward the axis, an outer face opposite to the inner face, first and second ends, a lower generatrix, and a length corresponding to a distance separating the first and second ends,
at least one stiffening band, which is pressed against the duct over at least a portion of the length, extending along a longitudinal direction substantially parallel to the axis of the duct and having, at least in one state, considerable rigidity along the longitudinal direction, and
wherein the at least one stiffening band is metallic and configured to deform elastically between a rolled-up state, when cross sections of the at least one stiffening band are rectilinear, and an elongate and rigid state, when the cross sections of the at least one stiffening band are curved,
the at least one stiffening band having a first surface pressed against the duct, curved and concave in the elongate and rigid state.

2. The pipe as claimed in claim 1, wherein each stiffening band comprises first and second lateral edges that are substantially parallel to the longitudinal direction and positioned on either side of the lower generatrix of the duct.

3. The pipe as claimed in claim 1, wherein the first and second lateral edges are positioned substantially symmetrically in relation to the lower generatrix.

4. The pipe as claimed in claim 1, wherein the pipe comprises at least one connection connecting the at least one stiffening band and the duct.

5. The pipe as claimed in claim 1, further comprising cutouts in the at least one stiffening band.

6. An aircraft comprising the pipe as claimed in claim 1.
